(19) United States
(12) Patent Application Publication
(10) Pub. No.: US 2024/0265362 A1
(43) Pub. Date: Aug. 8, 2024

(54) ESTABLISHMENT OF FRACTIONAL OWNERSHIP OF DIGITAL ASSETS AND NON-FUNGIBLE TOKENS FOR INTANGIBLE AND TANGIBLE ITEMS USING BLOCKCHAIN OR OTHER TRACKING METHODS

(71) Applicant: FILIPE PEDROSO, Bridgewater, NJ (US)

(72) Inventor: FILIPE PEDROSO, Bridgewater, NJ (US)

(21) Appl. No.: 18/105,797

(22) Filed: Feb. 3, 2023

(51) Int. Cl. G06Q 20/12; G06Q 30/08

(52) U.S. Cl. CPC G06Q 20/1235; G06Q 30/08; G06Q 2220/00

(57) ABSTRACT

A computer-implemented method of fractionalizing digital assets or NFTs includes under control of one or more configured computing systems, fractionalizing the digital asset or NFT in the virtual and non-virtual world by providing a chain-of-ownership blockchain or other data to authenticate fractional ownership; or by proving a visualized representative part of the fractionalized ownership of the digital asset; and establishing an exchange market for the creation, sale, transfer or exchange of fractionalized digital assets.

### CROSS-REFERENCE TO RELATED APPLICATIONS

The present patent application claims benefit of U.S. Provisional Application Ser. No. 63/306,335, filed Feb. 3, 2022, the disclosures of which is hereby incorporated by reference herein.

### BACKGROUND OF THE INVENTION

### Field of the Invention

The present patent application is generally related to the retail industry, and is more particularly related to electronic commerce systems; and the present patent application is also related to the finance services industries, and more particularly related to the investment, transfer and ownership of digital assets. The present patent application is also related to the field of distributed ledgers; more particularly, it is related to generating customized non-fungible tokens (NFTs) and digital assets that can be stored in distributed ledgers.

### Description of the Related Art

Digital assets are typically sold in their entirety and exchanged for consideration through the public marketplace in their entirety. Digital assets, such as a non-fungible token (NFT), don't have a practical way of being divided into asset-portions for group ownership. This invention uses blockchain, data, and a visual representative part-system to create fractional assets of digital assets, and a system and method to sell, transfer, resell or trade a portion of an entire digital asset and NFTs.

An “asset” within this application is broadly defined anything, such as any product, good, service, data, file, or item, whether tangible or intangible, that may be owned by a person or entity.

A “digital asset” is commonly defined as “anything that is created and stored digitally, is identifiable and discoverable, and has or provides value.” [Source: https://www.investopedia.com/terms/d/digital-asset-framework.asp] Wikipedia defines “digital assets” as “anything that exists only in digital form and comes with a distinct usage right. Data that do not possess that right are not considered assets. Digital assets include but are not exclusive to: digital documents, audible content, motion picture, and other relevant digital data that are currently in circulation or are, or will be stored on digital appliances such as: personal computers, laptops, portable media players, tablets, data storage devices, telecommunication devices, and any and all apparatuses which are, or will be in existence once technology progresses to accommodate for the conception of new modalities which would be able to carry digital assets; notwithstanding the proprietorship of the physical device onto which the digital asset is located. [Source: https://en.wikipedia.org/wiki/Digital_asset]

The term “fractional” and its variations are used throughout this invention to indicate the fractional ownership of a digital asset or NFT. As used throughout this document, “fractional ownership” means a “partial or percentage ownership in the asset.” Collectively, all the fractional owners of a digital asset collectively own 100% of the digital asset, while individually each fractional owner of the digital asset own whatever equity percent portion he or she purchased at the time of execution.

A “NFT”, or non-fungible token, are commonly defined as “assets that have been tokenized via a blockchain. They are assigned unique identification codes and metadata that distinguish them from other tokens. NFTs can be traded and exchanged for money, cryptocurrencies, or other NFTs. [Although] cryptocurrencies are tokens as well; the key difference is that two cryptocurrencies from the same blockchain are interchangeable—they are fungible. Two NFTs from the same blockchain can look identical, but they are not interchangeable.” [Source: https://www.investopedia.com/non-fungible-tokens-nft-5115211]

According to Wikipedia, a “non-fungible token (NFT) is a unique digital identifier that cannot be copied, substituted, or subdivided, that is recorded in a blockchain, and that is used to certify authenticity and ownership. The ownership of an NFT is recorded in the blockchain and can be transferred by the owner, allowing NFTs to be sold and traded.” [Source: https://en.wikipedia.org/wiki/Non-fungible_token]

Since digital assets and NFTs are not in themselves sub-dividable, a need arrises for this invention to provide a means for fractional ownership of a single digital asset and NFT.

Dividing a digital asset into fractions or parts that are easily owned, sold, tracked, transferred, and managed, has a significant value in the marketplace for part-ownership transactions, joint-ownership of assets, fractional-ownership of assets, and the general trade of goods, services, and things (tangible and intangible). This invention establishes these functions using a new system and methods described in this document.

It is common in society with historic precedence for people to co-own physical assets such as homes, cars and businesses. However, the co-ownership of digital assets is a novel idea of the modern era, and a system and method establishing an authentication of ownership while providing for the fractionation of the digital asset into various equity parts for ownership has not existed.

Parts of a physical asset have traditionally been divided by way of a contract and written documentation. This is a cumbersome procedure that is often complicated by legal procedures, contractual reviews, documents that may be lost or difficult to track, difficult to find buyers, and at times not practical to fund. For example, a NFT is a digital item that has no physical way of dividing in itself. This invention solves all these problems by making it possible to easily divide any asset, by dividing the asset into representative parts. These parts can then be owned, sold, transferred and exchanged, in a practical way. Using the example of the NFT, the ownership of a single, unique NFT are already incorporated into the blockchain but this invention further provides a way for the NFT to be fractionalized into parts for co-ownership with ownership verification through the blockchain. Whether through additions to its blockchain, or incorporating the visual part system explained herein, this invention makes co-ownership of digital assets a practical reality. Other variants of the system and/or methods of fractional ownership of digital assets and NFTs are described within this document.

In spite of the economic growth of the NFT market in the recent few years, there is currently no system in existence that provides a method for the crowdfunding of an NFT or multiple NFTs by permitting an NFT owner to divide the NFT into parts, each part having a unique value and collectively totaling the total cost of the parent NFT.

Thus, there remains a continuing need for ecommerce and financial systems and methods that use computer software, the internet, on-line markets, economic methodologies, and financial principles, to overcome the above deficiencies, and allow individuals to purchase and obtain fractional ownership of digital assets and NFTs.

The invention of virtual worlds, such as the metaverse or other computer systems providing immersive virtual experiences, further support a need for this invention, as in such virtual worlds all assets are potentially digital. The co-ownership of such digital assets necessitates a method and system for creating fractionalized digital assets, and a market for the exchange of such fractionalized digital assets.

### SUMMARY OF THE INVENTION

In one embodiment each fractional portion of the digital asset is linked to a blockchain, NFT, or other reliable digitally tracking method. When an item or part is divided into more parts, each new part is designated a blockchain, NFT, or other reliable digitally tracking method, that can identify and track and link to the main item before its division into parts so that there is a continual of transaction, tracking and authentication. In another embodiment, the link of the digital tracking method has some or all of the information within its blockchain, NFT, or other digital tracking method.

In another embodiment, the digital asset or NFT's blockchain is supplemented or amended to include the fractional owner's name and the amount of ownership. Another embodiment provides a means to use data to maintain fractional owner(s) information.

In one embodiment, parts are represented using a visual system (FIG. 4). In another embodiment, parts are represented using descriptive written words. The parts become representative and show ownership of a portion of the item. These parts are assets that can be individually or collectively exchanged, sold, given, or otherwise disposed in any legal fashion.

By dividing the digital asset into specific parts, the part-asset can be visually represented and identified.

Each fractionalized part can be identified with a unique identifier and ownership traced using any type of identifier, such as a number, data, blockchain, or other method providing credible identification of the part. In one embodiment, the part is displayed visually. In another embodiment, the part or fractional ownership is explained or identified using written words.

In one embodiment, parts become an easily identified representation of the ownership of the digital asset with a registry of such ownership. If ownership changes, the registry is updated. Ownership is easily traced and documented.

Buyers of the digital asset can purchase one or more parts, each part representing a specific ownership interest in the overall digital asset. The part is then representative and shows ownership to the contributor of the portion of the asset that the parts represent. By way of example, if an asset is valued at $1,000 and divided into 10 parts, each part would have a value of $100, so if a contributor purchased 3 parts, this contributor would own $300 of the asset or 30%. Digital asset value can be a fixed amount or based on market value with fluctuations based on market conditions or principles of supply and demand.

The parts establish an asset class in the overall asset, each representing a particular portion of ownership in the total asset. These parts can then be resold or transferred to others, maintaining its respective proportion of ownership interest in the overall asset.

In another embodiment, an exchange market is established where people can create, buy, sell and trade the parts or fractions of their digital assets.

In another embodiment, the parts or fractional ownership have an internal ability to be bought, sold, transferred and traded without the necessity of an exchange market.

In another embodiment, a marketplace can be established where the parts are valued at supply-demand principles, similarly to a stock market, with live trading of parts and fractional digital assets.

In another embodiment, various marketplaces can keep track of the part ownerships and values, by incorporating blockchain or other tracking technology.

In another embodiment, parts or fractional ownership can be further divided into more parts or fractional ownership assets.

Parts can be created in both tangible and intangible asset classes. Anything conceivable and described in words or imagery can be divided into parts.

Parts and fractional ownership of a digital asset can all have the same value, or individual values.

The parts or fractional ownership can be generated by a computer automatically or a user can designate the number of parts and their respective value. The value can be $0 or higher. Collectively, the parts represent a known percent of ownership, from greater than 0 to 100%.

In one embodiment the invention is run by a computer system. In another embodiment, the invention is manually tracked by individuals in ledgers or other documentation.

In one embodiment the invention is displayed on a computer system with a display monitor. In another embodiment, the invention is displayed on a smart phone or a tablet, or any method available to display or project information.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

### BRIEF DESCRIPTION OF THE DRAWINGS

FIG. 1A-1B show a digital asset authenticated with a NFT and the fractionation of the digital asset using the blockchain to provide ownership to various owners in the same NFT.

FIG. 2A-2B show a digital asset and the fractionation of the digital asset using the flow of data to provide ownership to various owners in the same digital asset.

FIG. 3 shows a visual display for an electronic device, in accordance with various embodiments of the present patent application.

FIG. 4 shows a visual display for an electronic device, in accordance with various one embodiment of the present patent application.

FIG. 5 shows a visual display for an electronic device, in accordance with one embodiment of the present patent application.

FIG. 6 shows a visual display for an electronic device, in accordance with various embodiment of the present patent application.

FIG. 7 shows a visual display for an electronic device, in accordance with various embodiments of the present patent application.

FIG. 8 shows a visual display for an electronic device, in accordance with various embodiments of the present patent application.

FIG. 9 shows a visual display for an electronic device, in accordance with various embodiments of the present patent application.

FIG. 10 shows a visual display for an electronic device, in accordance with various embodiments of the present patent application.

### DETAILED DESCRIPTION OF PREFERRED EMBODIMENTS

Various embodiments of the present patent application disclose a computer platform, systems and methods that enables one or more individuals to own the same NFT and its underlying digital asset. In other various embodiments of the present patent, NFTs are used to crowdfund physical and nonphysical items.

In one embodiment, a computer platform is used to create or add to the NFT blockchain an ownership identification of part ownership. Traditionally, NFTs have identified the ownership through the blockchain, but only one owner at a time has been so identified. In one embodiment, by modifying the blockchain, multiple owners can be identified and their respective portion of ownership known. This blockchain, and its history, can be viewed by others, authenticating the NFT, its asset, and fractional ownership of all its individual members.

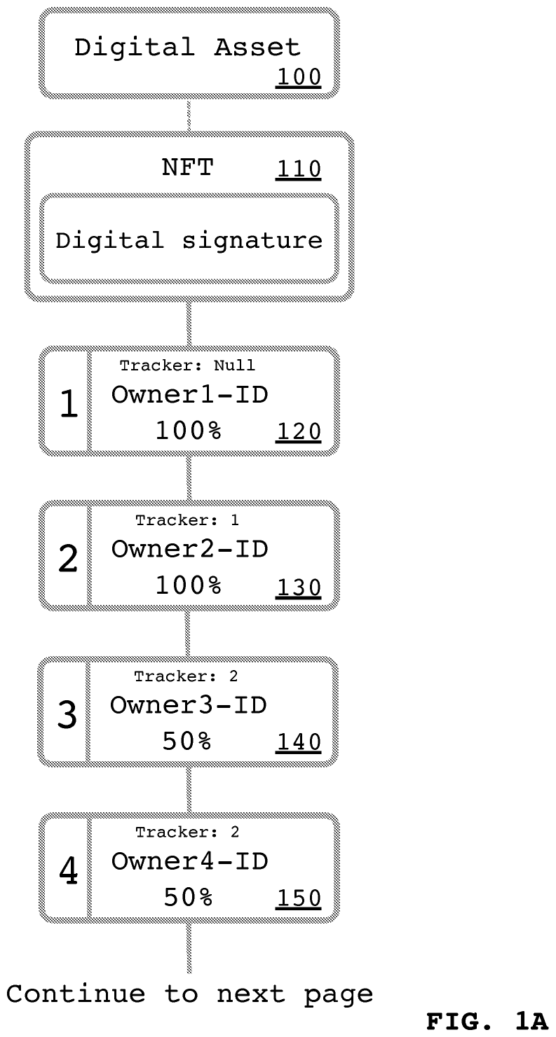

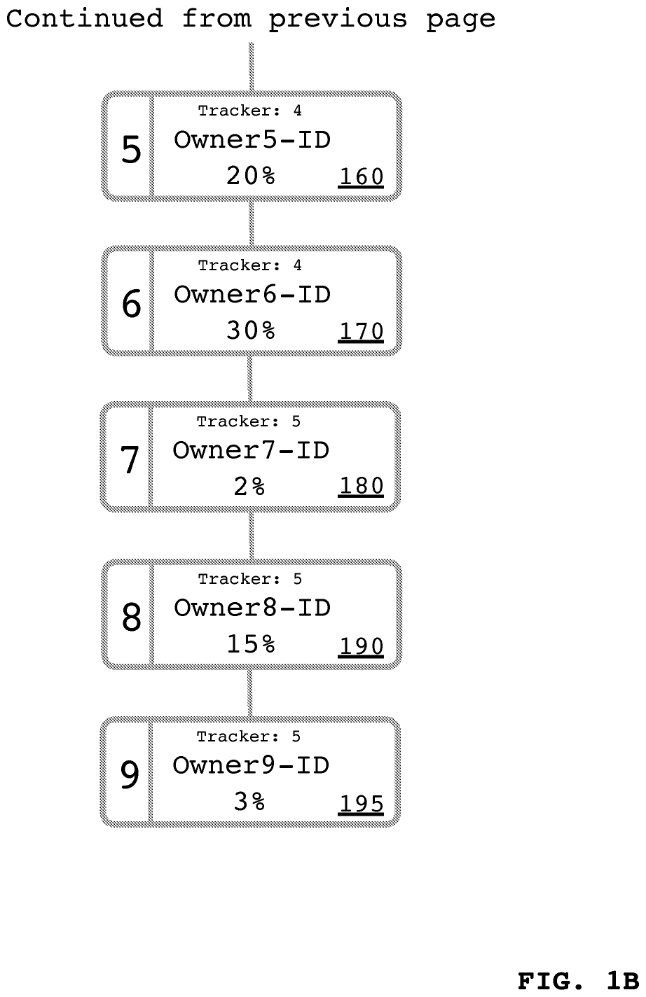

In one embodiment, referring to FIG. 1, a digital asset is identified 100. The NFT is created, and all the traditional and commonly identification information is added to the initial NFT's blockchain 110, and then upon ownership, the initial ownership blockchain information 120 is added to the blockchain, and as the NFT is transferred to someone else, the new owner's information 120 is further added to the blockchain. In one embodiment, an owner 130 owning 100% of the NFT can sell or transfer a fractional ownership of the NFT so that two or more people have ownership of the NFT, as is further provided in FIG. 1, wherein a 100% owner, identified on the blockchain 130, transfers their ownership to two separate owners, now identified on the blockchain (130 and 140) with their identification and ownership shares within the blockchain. The digital asset's ownership has effectively been fractionated, so that now, in this example, there are two co-owners. In one embodiment there can be two or more co-owners of the NFT.

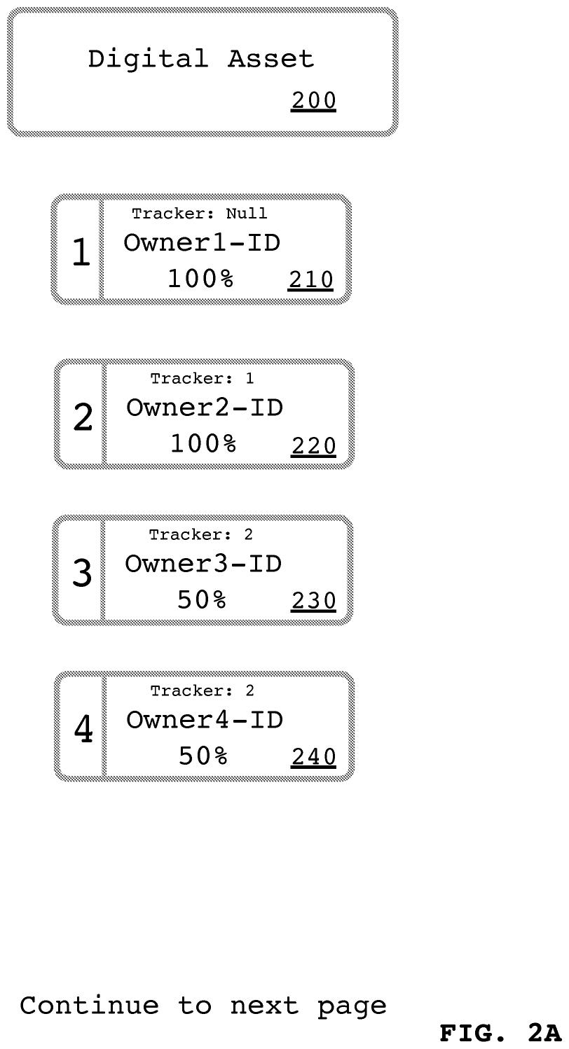

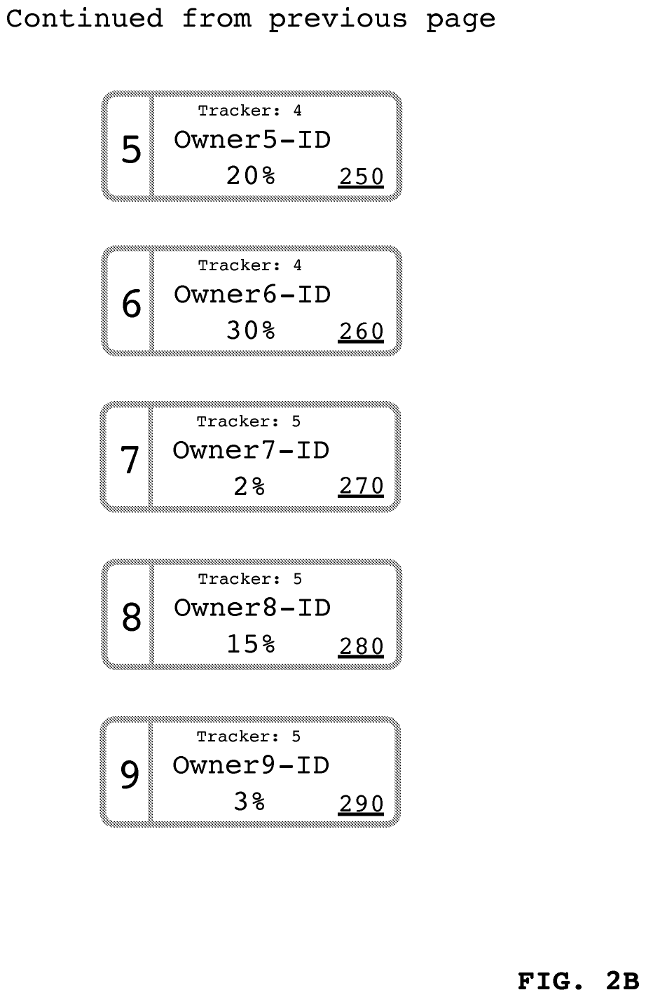

In another embodiment, a fractional owner of the NFT can further fractionalize their ownership share of the NFT into further fractional parts. Referring to FIG. 1, in one embodiment, the fractional owner of the NFT, represented by a portion of the blockchain 150, splits the fractional ownership, in the figure the example of 50% is provided but it can be any amount, into smaller ownership parts of two or more; looking at FIG. 1, this new smaller ownership parts are identified on the blockchain (160 and 170). In this example (the precise percent ownership can be any number as can the amount of parts the NFT is fractionalized, and the use of specific percent values and part numbers in FIG. 1 and in this text is for explanation only as one example to explain the process), the NFT fractional owner that is identified on the blockchain 150 fractionalized that portion of the NFT ownership into two parts now identified on the blockchain as provided in FIG. 1 160 (20% ownership) and 170 (30%). Looking at FIG. 1 and FIG. 2, by example of this, the owners of the digital asset or NFT 100 or 200 and their respective ownership percents are: Owner9 owns 3%, Owner8 owns 15%, Owner7 owns 2%, Owner6 owns 30%, and Owner3 owns 50%.

In another embodiment, fractional ownership of the NFT can be represented using any visual system that can represent multiple parts or various owners. In an embodiment, on a screen, display or any other method of viewing information, an image representing a digital asset or NFT can be shown in any possible manner. In another embodiment, the NFT image can be divided by lines or representing in any other manner that symbolize multiple parts, so that fractional owner(s) can visualize their ownership interest in the digital asset or NFT. In one embodiment, this visualization method is the way to keep track of digital asset or NFT fractional ownership. In another embodiment, this visualization method is used simultaneously with other ways of tracking digital asset or NFT fractional ownership as provided within this patent.

In one embodiment, a NFT's blockchain can be supplemented with additional information when a NFT's ownership is fractionalized into a plurality of owners. In one embodiment, the blockchain's block is added a data set that includes the new owner's information with a reference back to the prior owner who fractionated the ownership. This is illustrated in a simple form in FIG. 1, whereby the new Owner2 130 has a “Tracker” identifying that its ownership was obtained from Owner1 120; similarly, both Owner3 140 and Owner4 150 obtained their fractionalized portion of the NFT from Owner2, and so the “Tracker” identifies owner 2. In another embodiment, any method by which a chain-of-ownership may be tracked is acceptable.

In one embodiment, the digital asset was created or authenticated via tokenization on a blockchain. In another embodiment, the digital asset was created or authenticated via data included in, attached to, or independently stored to the ownership data file.

In one embodiment, the fractionating of one's ownership in the NFT results in an append, amend or modification of the non-fungible token's blockchain so as to include information about the owner's identification and the quantity of the new owner's fractional ownership of the digital asset.

In another embodiment, the fractionating of one's ownership in the digital asset results in an append, amend or modification of blockchain so as to include information about the owner's identification and the quantity of the new owner's fractional ownership of the digital asset. In another embodiment, the fractionating of one's ownership in the digital asset results in an append, amend or modification of ownership data so as to include information about the owner's identification and the quantity of the new owner's fractional ownership of the digital asset.

In another embodiment, digital assets have their ownership tracked within the digital asset's metadata or within the data of the digital asset itself. In FIG. 2, a representation of one way that data can be used to process and identify fractional ownership of a digital asset is provided; however, any way that such fractional ownership of a digital asset or NFT can be identified using written words is included within this invention.

Referring to FIG. 2, a digital asset exists 200. In one embodiment, the ownership 210 information and data is attached to the data of the digital asset. In one embodiment this data becomes inclusive within the data of the digital asset. In another embodiment, this data is separate from the digital asset. In one embodiment, the ownership information 210 is added to the data, and as the NFT is transferred to someone else, the new owner's information 220 is further added to the data. In one embodiment, an owner 220 owning 100% of the digital asset can sell or transfer a fractional ownership of the digital asset so that two or more people have ownership of the data asset, as is further provided in FIG. 2, wherein a 100% owner, identified on the data 220, transfers their ownership to two separate owners, now identified on the data (230 and 240) with their identification and ownership shares. In one embodiment, further ownership splits are continuously saved to the data so that a historical tracking of prior owners is readily available for authentication of ownership.

In another embodiment, digital assets or NFT parts are represented using descriptive written words on a ledger or database. The parts become representative and show ownership of a portion of the item.

In another embodiment, a fractional owner of the digital asset or NFT can further fractionalize their ownership share of the digital asset or NFT into further fractional parts and such ownership being tracked in any of the methods previously described. Referring to FIG. 1 and FIG. 2, in one embodiment, the fractional owner of the digital asset or NFT, represented by a portion of the blockchain 150 or data 240, splits the fractional ownership, in the figure the example of 50% is provided but it can be any amount, into smaller ownership parts of two or more; this new smaller ownership parts are identified on the document (160 and 170, or 250 and 260). In this example (the precise percent ownership can be any number as can the amount of parts the digital asset or NFT is fractionalized, and the use of specific percent values and part numbers in FIG. 1, FIG. 2 and in this text is for explanation only as one example to explain the process), the digital asset or NFT fractional owner that is identified on the blockchain 150 or data 240 fractionalized that portion of the digital asset or NFT ownership into two parts now identified on the document as provided in FIG. 1 160 or FIG. 2 250 (20% ownership) and FIG. 1 170 or FIG. 2 260 (30%). In one embodiment, fractional owner(s) can further fractionalize their fractional shares into further fractionalized portions. Looking at FIG. 1 and FIG. 2, by example of this, the owners of the digital asset or NFT 100 or 200 and their respective ownership percents are: Owner9 owns 3%, Owner8 owns 15%, Owner7 owns 2%, Owner6 owns 30%, and Owner3 owns 50%.

In another embodiment, the digital asset or NFT parts are assets that can be individually or collectively exchanged, sold, given, or otherwise disposed in any legal fashion.

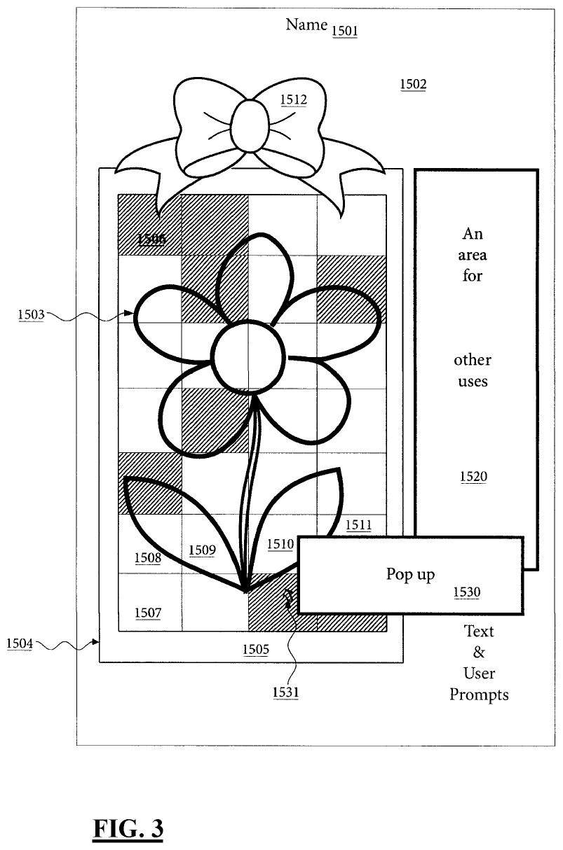

In one embodiment, by dividing the asset into specific parts, such as in FIGS. 3, 6, 7, 8, 9 and 10, the part-asset can be visually represented and identified; the shape of the part, whether square, circle, or otherwise makes no difference to the functionality of this invention. In the figures, the asset is represented by various shapes; these shapes are examples only and representative of any asset, tangible or intangible.

Each part of the digital asset or NFT can be identified with a unique identifier and ownership traced using any type of identifier, such as a number, blockchain, or other method providing credible identification of the part. In one embodiment, the part is displayed visually, such as in FIGS. 3, 6, 7, 8, 9 and 10. In another embodiment, the part is explained or identified using written words.

In one embodiment, digital assets or NFT fractionalized parts become an easily identified ownership of the item with a registry of such ownership. In one embodiment, if ownership changes, the registry is updated. Ownership is readily traced and documented.

In one embodiment, buyers of the digital asset or NFT or its fractional parts can purchase one or more parts, each part representing a specific ownership interest in the overall asset. The part is then representative and shows ownership to the fractional owner of the portion of the NFT asset that the parts represent. By way of example, if an NFT is valued at $1,000 and divided into 10 parts, each part would have a value of $100, so if a fractional owner purchased 3 parts, this fractional owner would own $300 of the NFT asset or 30%. Asset value can be a fixed amount or based on market value with fluctuations based on market conditions or principles of supply and demand.

In one embodiment, the parts establish sub-asset class(es) in the overall NFT asset, each representing a particular portion of ownership in the total NFT asset. These parts can then be resold or transferred to others, maintaining its respective proportion of ownership interest in the overall NFT asset.

In another embodiment, an exchange market platform is established where people can buy, sell and trade the parts or fractional ownership of their digital assets.

In another embodiment, the parts have an internal ability to be bought, sold and traded without the necessity of an exchange marketplace.

In another embodiment, a financial market can be established where the parts are valued at supply-demand principles, such as a stock commodity market, with live trading of parts or fractional ownerships. Financial market is defined as “any place or system that provides buyers and sellers the means to trade financial instruments.” [Source: https://www.occ.treas.gov/topics/supervision-and-examination/capital-markets/financial-markets/index-financial-markets.html]Investopedia defines “financial markets” to “refer broadly to any marketplace where the trading of securities occurs, including the stock market, bond market, forex market, and derivatives market, among others.” [Source: https://www.investopedia.com/terms/f/financial-market.asp]

In one embodiment, a financial market can be established for the trade of fractional digital assets and fractional NFT ownership. In one embodiment, the financial market operates similar to the New York Stock Exchange or NASDAQ, whereby digital assets or NFTs are listed, information about the digital asset or NFT provided, and fractional ownership sold and traded in a financial market-like environment. In another embodiment, the financial market operates in any manner possible so long as the digital asset(s) or NFT(s) can be fractionalized and their fractional portions sold, bought, and exchanged in this financial market. In another embodiment, this fractional market is a public entity or a private entity. In another embodiment, this fractional market operates privately or is available to anyone in the public. In another embodiment, any owner of the fractional share of the digital asset or NFT can list it for sale in the financial market, so that another person may either place a bid or straight out purchase the digital asset or NFT for asking price. In another embodiment, the financial market provides a way for anyone to individually sale, buy or trade each fractional share of the digital asset or NFT one-on-one, or one-to-many, or in any way that items are commonly sold or exchanged.

In another embodiment, various financial markets can keep track of the digital asset or NFT fractional ownerships and values, by incorporating blockchain or other tracking technology.

In another embodiment, NFT fractional ownership can be further divided into more parts. In one embodiment, NFT fractional ownership is further fractionalized so that a partial ownership is divided into two or more fractional shares of the original fractionalized NFT ownership. By way of example, FIG. 1 showed this when ownership 150 is further fractionalized into two new fraction ownerships identified as 160 and 170 in the figure. In one embodiment, fraction ownership 160 and/or fraction ownership 170 can be further fractionalized or divided into separate NFT fraction ownership; for example, fraction ownership 160 is by way of example shown to own 20% of the NFT asset, so in an embodiment, this ownership 160 can be further fractionalized in two or more parts, each having the same or their distinct values, so that collectively these new parts represent 20% of the NFT ownership. In another embodiment, this fractionalization of the NFT ownerships can be fractionalized indefinitely so that collectively all the NFT fractions equal 100% of the total NFT asset ownership. In another embodiment, one NFT part of the overall asset for example with 16 parts, is then subdivided into 25 parts; for example, if the main asset composed of 16 parts is valued at $400, where each part is worth $25, a part can be further divided into subparts of 25 each of those subparts worth $1 each so collectively the subparts are worth $25, the value of one part of the main asset. In another embodiment, this subdivision of parts can occur once or multiple times, and subparts can be further divided into additional subparts, and subparts divided into sub-subparts, and so on and so on.

In one embodiment, digital assets or NFT parts and/or fractionalization can be created in both tangible and intangible asset classes. In another embodiment, anything conceivable and described in words or imagery can be divided into parts.

In one embodiment, NFT fractionalization is created for a NFT representing a digital asset. In another embodiment, NFT fractionalization is created for a NFT representing ownership in a physical asset. In another embodiment, NFT fractionalization is created in assets in a digital computer world, such as the metaverse or other computer virtual environments.

In another embodiment, digital assets or NFT parts can all have the same value, or individual values. For example, a digital asset or NFT asset of $1,000 may have 5 parts valued at $100 each, and 10 parts valued at $50 each. In another embodiment, the digital asset or NFT asset may be divided so that only a portion of the asset value is in NFT parts and the rest not. For example, an asset valued at $1,000 may only provide $500 in digital asset or NFT fractionalized parts, the rest not sold by way of fractionalization, so that, by example, 10 parts of $50 are available. In this example, the owner of the asset decided to make only 50% of the asset available for sale through the digital asset or NFT fractionalization system.

In one embodiment, the fractionalization and/or parts can be generated by a computer automatically. In another embodiment, a user can designate how the digital asset or NFT is fractionalized into the number of fractional ownership shares and their respective values. In another embodiment, the value can be $0 or higher. In another embodiment, collectively, the fractional digital asset or NFT parts represent a known percent of ownership, from greater than 0 to 100%.

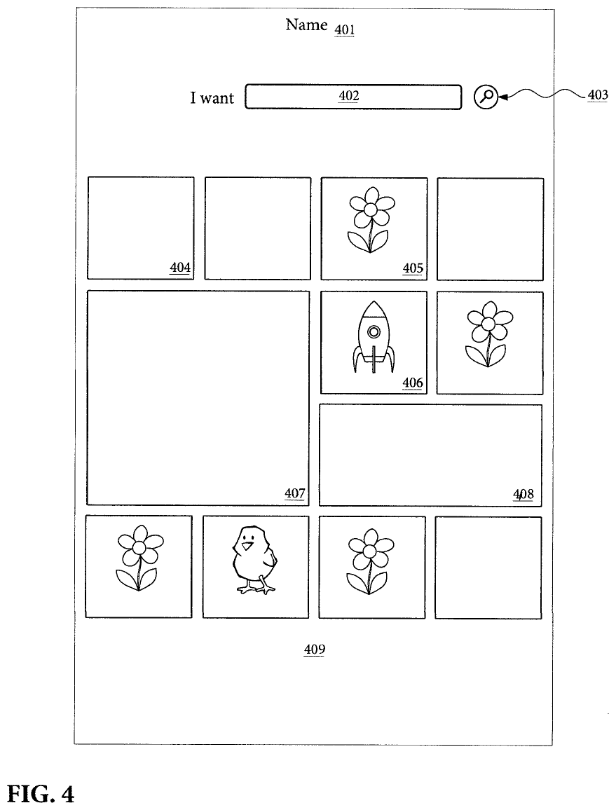

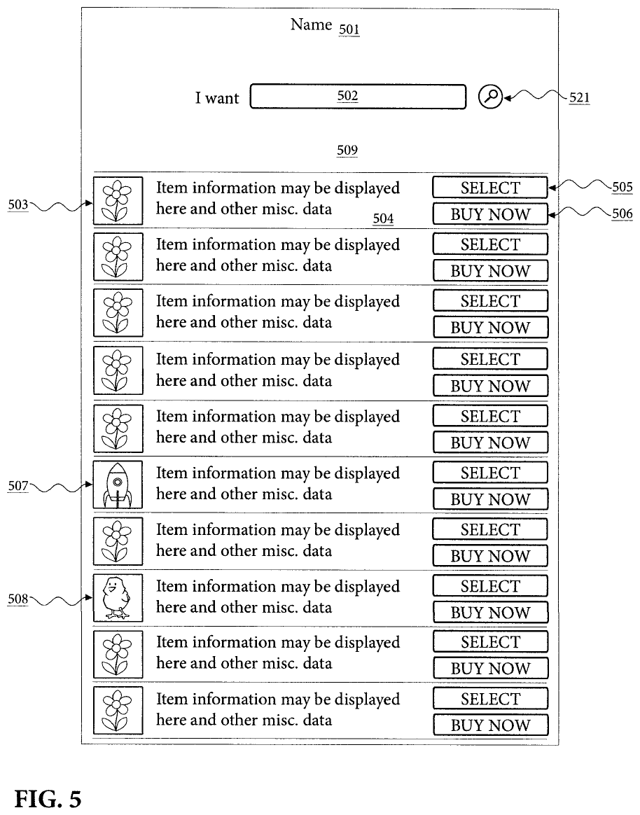

In another embodiment, FIG. 4 shows examples of how various digital assets and/or the fractionalized digital assets may be displayed together on a webpage, but the precise manner is not important, so long as the digital assets or the fractionalized digital assets have a visual reference or description that makes the digital assets(s) identifiable. In another embodiment, fractional digital asset or NFT parts are described through words, example FIG. 5, with or without accompanying visual representation. In another embodiment, one or more digital asset(s) or NFTs, and their fractional ownership portions available for sale or not, may be listed.

In another embodiment, NFT fractional ownership is provided through the blockchain of the NFT itself. In another embodiment, various methods as described here, separately or jointly, are used to identify and keep track of the digital asset or NFT's fractional ownership.

In one embodiment the invention is run by a computer system. In another embodiment, the invention is manually tracked by individuals in ledgers or other documentation.

In one embodiment the invention is displayed on a computer system with a display monitor. In another embodiment, the invention is displayed on a smart phone or a tablet, or any method available to display or project information. In another embodiment, the invention is not displayed but stored in computer system(s).

In one embodiment each fractional digital asset or fractional NFT part is linked to a blockchain, another NFT, cryptocurrency, data, or other reliable digitally tracking method. In another embodiment, when a NFT or NFT part is divided into more parts, each new part is designated a blockchain, NFT, cryptocurrency or other reliable digitally tracking method, that can identify and track and link to the NFT item that existed before its division into parts so that there is a continual of transaction, tracking and authentication. In another embodiment, the link of the digital tracking method has some or all of the information within its blockchain, NFT, or other digital tracking method. In another embodiment, the information regarding each fractional digital asset is stored in data within the digital asset, linked to the digital asset, or independent of the digital asset.

In one embodiment, the system(s) disclosed herein may be operated using any internet-based device having the ability to access a computer and connecting multiple computers, such as by using a computer, a mobile device, a tablet, or any future means of communicating and displaying the information from the computers.

In one embodiment, the fractionalized digital asset may be sold, purchased or exchanged in a public or private market, exchange, or other means of exchanging value for a digital asset. In one embodiment, a user can be shown one or more fractionalized digital assets available for purchase, search for fractionalized digital assets, and be provided with one or more visually represented fractionalized digital asset that are available for purchase or exchange.

In one embodiment, the fractionalized digital asset may be represented on a visual screen through the use of words or imagery (including any available methods of displaying images or video). In another embodiment, the fractionalized digital assets are stored within computer system but not displayed. In another embodiment, the fractionalized digital assets are sold or exchanged without a visual representation but instead through direct modification of the data, torrent, token, or blockchain associated with the digital asset.

In another embodiment, the fractionalized digital asset may be sold, purchased or exchanged directly between the parties.

In one embodiment, the visual representation of the digital asset may be displayed on a display. In one embodiment, the item is automatically fragmented into parts. In one embodiment, each part is designated a monetary value. The monetary value may or may not be customized by the digital asset fragment owner. In one embodiment, the total of all the parts making up the fully funded fragment of the digital asset may be the price plus fees or other costs. In one embodiment, the fractionalized digital asset part prices may be determined using the total value prior to fragmentation and dividing by total fragmented parts and, if applicable, other fees. In an alternate embodiment, the individual fragmented digital assets are individually or in groups assessed a price, plus, if applicable, any other costs. The systems and methods disclosed herein are not limited in the way that fragmented digital asset parts' values are calculated or which costs and fees are associated with each particular part.

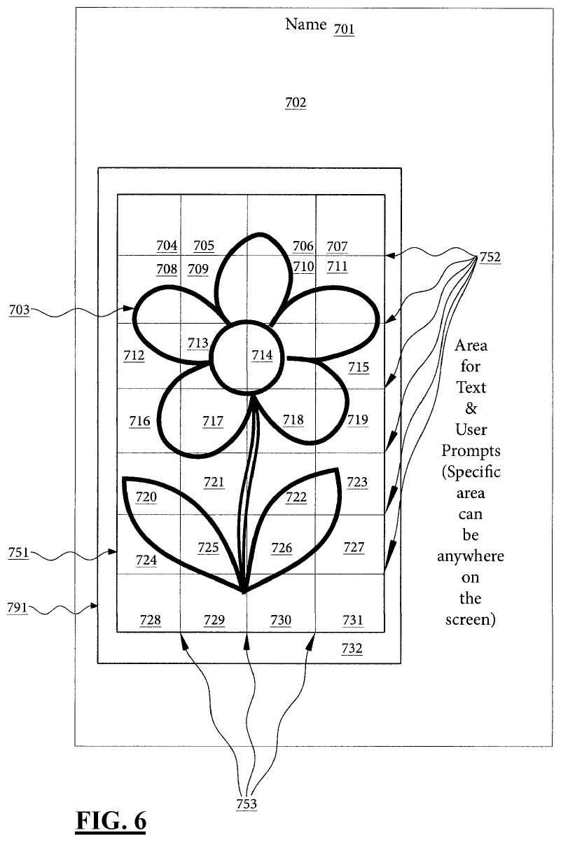

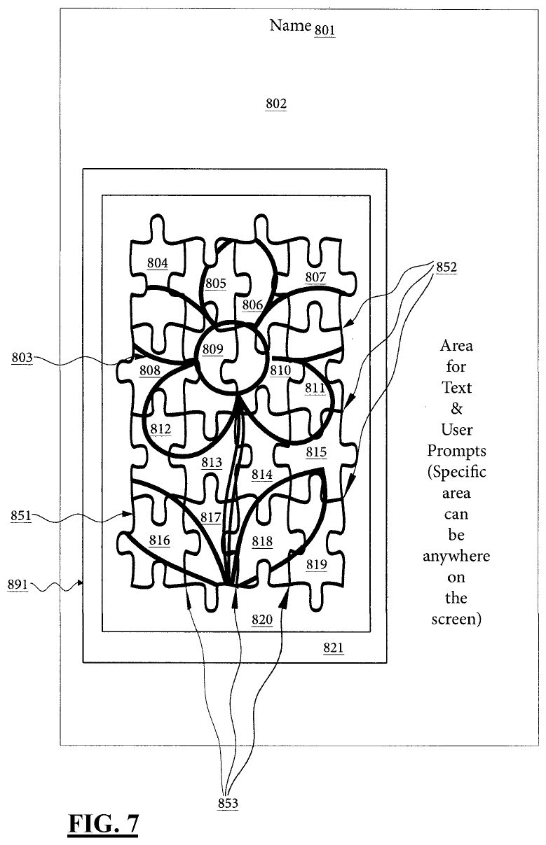

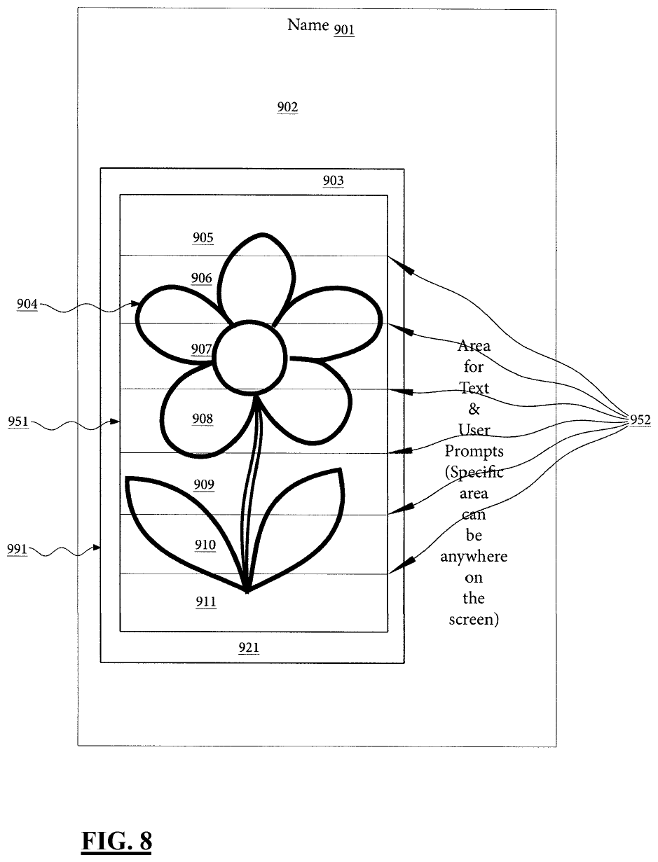

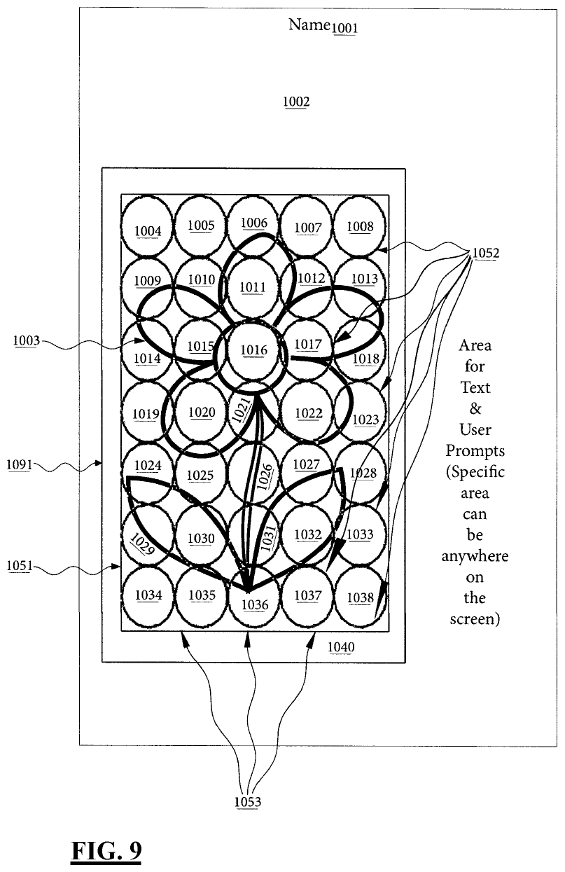

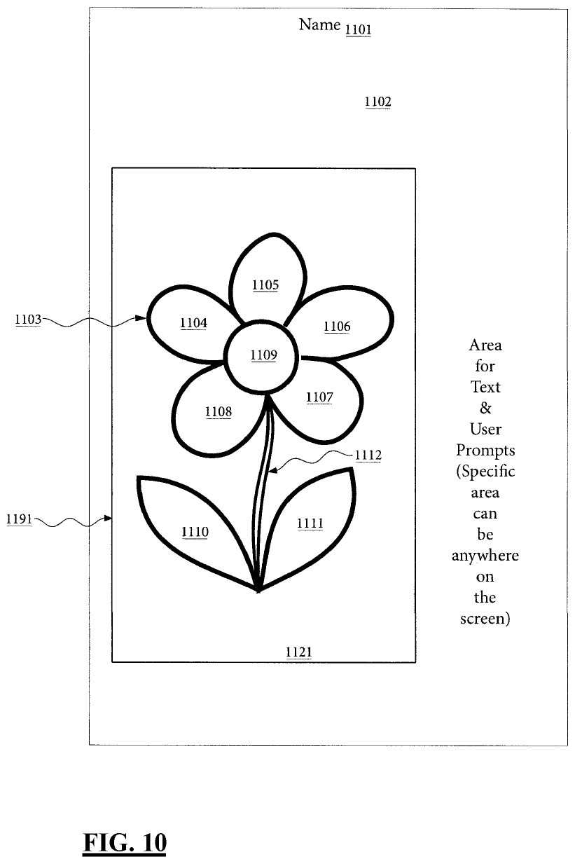

In one embodiment, the system and methods disclosed herein enables a digital asset to be divided into parts so that each part may be purchased individually and/or collectively at a later time by the buyer(s). There are several ways in which the digital asset may be visually represented as divided into parts so that each part can be visualized and the digital asset assessed its own value. In one embodiment, the digital asset visual representation is placed inside a boundary, such as a box, rectangle, oval, circle, or any shape or outline, and then parts are created by compartmentalizing and/or converting a whole area inside its boundaries into individual sections, such as illustrated by way of examples in FIG. 6, FIG. 7, FIG. 8, FIG. 9, and FIG. 10. The method by which the digital asset visual representation is divided into parts is not limiting, as it is possible to divide a whole piece into many parts in an almost infinite way.

Referring to FIG. 6, in one embodiment, the digital asset visual representation may have the shape of a flower 703. In one embodiment, the flower has a rectangle boundary 751. In one embodiment, the rectangle may be divided into parts by horizontal lines 752 and vertical lines 753. These lines 752 and 753 create square-like shapes; these square-like shapes create the individual parts identified in FIG. 6 by reference numbers 704-731. The item, shown by way of example as a flower 703, has a total execution price—its fully funded price. In one embodiment, each individual part 704-731 has a value less than the total price of all parts, so that when all the individual parts 704-731 are summed together, they equal the total value of the digital asset.

In one embodiment, the “flower” referenced in the prior paragraph, and in other paragraphs that follow, is a graphic displayed as an example of an image that may represent the digital asset. In case that the digital item can be visually displayed, such as by way of example, a static digital art piece, the “flower” may be an image of visual-likeness to the digital art in a displayed format. In another embodiment, the “flower” could be any image that one decides to be representative of the digital asset. In another embodiment, such as instances in which a photograph or graphical representation of digital asset may not be available or preferred, the “flower” may be replaced by text or another generic graphical representation.

The market system disclosed herein may be used to divide one or more digital assets into fractionalized parts, such as those shown FIGS. 7, 8, and 9. In FIG. 7, the parts 804-819 are synonymous with the parts 704-731 in FIG. 6. In the embodiment of FIG. 7, the boundary of the digital asset's visual representation is marked by the border of the parts that look like puzzle pieces 851, which is similar to 751 in FIG. 6. Likewise, the horizontal 752 and vertical 753 lines creating separation for the parts in FIG. 6 are demonstrated by the horizontal puzzle lineage 852 flowing generally in a horizontal direction, although not linear, and the vertical puzzle lineage 853 flowing generally in a vertical direction, although not linear (FIG. 7). These boundary lines identify and create parts 804-819. In this example, each individual digital asset visual representation part 804-819 has a value less than the overall digital asset value, so that when all the individual parts 804-819 are summed together, they equal the full digital asset value.

Referring to FIG. 9, in one embodiment, the visual representation of the fractionalized parts of the digital asset 905-911 are synonymous with the parts 704-731 in FIG. 6. In the embodiment of FIG. 9, the boundary of the item is marked by the rectangle 951, which is similar to 751 in FIG. 6. Likewise, the horizontal 752 lines creating separation for parts in FIG. 6 are demonstrated by the horizontal lines 952 in FIG. 9. These boundary lines identify and create parts 905-911. It is relevant that in this example FIG. 9 the digital asset visual representation was not separated and divided with vertical lines as in FIG. 6 and FIG. 7. That is because the systems disclosed herein are not bound by the means by which the parts are made, or by which the parts are separated, but any way in which an item may be separated into parts and demonstrated in a display.

Referring to FIG. 9, in one embodiment, the parts 1004-1038 are synonymous with the visual representation of the fractionalized parts of the digital asset 704-731 in FIG. 6. In this example the boundary of the item is marked by the rectangle 1051, which is similar to 751 in FIG. 6. However, there are no horizontal lines 752 or vertical lines 753 creating the separation for parts as in FIG. 6. In FIG. 9, the boundary lines that create parts 1004-1038 are circles. In FIG. 9, the item is not separated and divided with lines as in FIGS. 7, 8, and 9. In the FIG. 9 embodiment, the digital asset visual representation is not bound by the means of which the parts are made, or by which the parts are separated, but any way in which a visual representation of the digital asset may be separated into parts and demonstrated in a display.

In one embodiment, the systems disclosed herein are not bound by the means of which the visual representation of the fractionalized digital assets are made, or by which the parts are separated, but any way in which the visual representation of the digital asset may be separated into parts and demonstrated in a display.

Referring to FIG. 2A, in one embodiment, at step 209, the system enables the digital asset owner to customize the digital asset visual representative's appearance and its surroundings. The digital asset visual representation, its container, and/or the area adjacent and traversing the container may be customized with imagery, decoration, patterns, colors, shapes, graphics, any visual graphic, and words.

In one embodiment, the number of digital asset visual representation parts of the fractionalized digital asset may exceed that which may be reasonable viewable on any one display size. In another embodiment, the number of parts of the digital asset visual representation may be divided into multiple pages or display areas. For example, a typical box has four sides. If each side of the box has 30 individual digital asset visual representation parts, then the four sides together would have four times thirty, or 120 digital asset visual representation parts. If a box has five sides, then using the same logic, this box could have five times thirty, or 150 parts. If a box has six sides, then using the same logic, this box could have six times thirty, or 180 parts. And so on. In this method, a digital asset visual representation can be divided into many parts, and be segmented into various sides, viewable to the user at one side at a time, so that collectively all the sides make up all the digital asset visual representation parts of the total digital asset visual representation. In another embodiment, the box may have any number of sides. In another embodiment, the box may have any number of digital asset visual representation parts. In another embodiment, the box may have any combination of sides and digital asset visual representation parts.

In another embodiment, digital asset visual representation may not require sides because all the parts are continuously displayed in order from top to bottom on a display screen, and, where necessary because of visual display room, with a scroll function that continues the digital asset visual representation down the visual experience.

In one embodiment, a display page may show the digital asset visual representation and its associated fractionalized parts. Potential buyers and users see the digital asset visual representation and its associated fractionalized parts. In this display, the users see the digital asset visual representation, its associated fractionalized parts, and other relevant information. In another embodiment, the digital asset visual representation and its associated fractionalized parts and its container and other information, if any, are displayed, with indicators for the available parts for purchase and the unavailable, already paid portions represented by the visual representation of the digital asset.

In one embodiment, if user selects or clicks or places the selector over an unavailable digital asset visual representation part, then, information regarding the purchased digital asset visual representation part may be displayed in any way possible to display information. The displayed information may include identification of the fractionalized digital asset, identification facts of the fractionalized digital asset, transactional information, or any other information that may be displayed or provided.

In one embodiment, an option is provided for any one to select or click or place a selector on the digital asset visual representation available parts. Available parts are those parts which are available for purchase. In another embodiment, these available parts, once selected for purchase are marked or identified on the display as selected for purchase with a graphical or textual marking. In another embodiment, if the user selects or clicks or places the selector over an available digital asset visual representation part, then the user is displayed, as a pop-up window or other method, the cost to purchase this portion of the fractionalized digital asset, other information, and a selector button to purchase or add to buy. This is demonstrated by way of example in FIG. 3, wherein a cursor or pointer or click or selector is shown as an arrow 1531 over an available part, and the pop-up window described herein is shown as a rectangle labeled “Pop up” 1530. The size of the rectangle box 1530 may vary by size, and in some platforms the pop-up may be replaced by opening a new display screen or internet browser screen. Also, by way of example, if the user moves the selector to another available digital asset visual representation part, then the current pop-up window preferably closes, and a new pop-up window preferably opens with the information and price associated with that available part.

In one embodiment, the user preferably selects available fractionalized digital assets by selecting digital asset visual representation part(s), one or more available, by clicking or selecting the available part(s). In one embodiment, the part(s) selected for purchase are marked or identified on the display as selected parts. The cost of each fractionalized digital asset is preferably added to and shown on the screen in any user interface design. In one embodiment, the potential buyer sees the total value of all the part(s) he or she selected. This information may be displayed in any method possible, and does not require a specific shopping cart.

In one embodiment, the potential buyer may select and unselect available digital asset visual representation part(s), one or more at a time, by clicking or selecting the available part(s), which are then identified as selected, but clicking or selecting again removes the part(s) from the parts selected for purchase. Using this method, a contributor may select and unselect any available part(s), and only purchases fractionalized digital assets associated with the part(s) so selected at the moment of checkout or purchase.

In one embodiment, the potential buyer selects the digital asset visual representation part(s), one or more available, in any method possible, and each part selected is added to the total purchase of all the fractionalized digital assets selected and represented by the part(s) for payment by the buyer. In one embodiment, the buyer finalizes the purchase of all of the selected fractionalized digital assets represented by the part(s).

In one embodiment, the shopping cart previously described may include any method of displaying the total amount of the anticipated purchase. In one embodiment, a diagram of a shopping cart is not necessary as any user interface design that shows the user the total amount is within the scope of this description.

In one embodiment, instead of a traditional shopping cart, the price for the fractionalized digital assets selected may be added and/or displayed to the user in any user interface design method possible. In one embodiment, the contributor may select final checkout, and a payment screen is presented to accept any allowable payment method. In one embodiment, it does not matter how this payment interface appears in design or function. In another embodiment, payment is made from account credits or funds previously deposited or funds transferred from other accounts.

Referring to FIG. 3B, in one embodiment, at step 319, the user may sign into the platform site account that is stored in the main database. In one embodiment, at any time, any user of the system disclosed herein may create an account by selecting the sign-in option. In one embodiment, a user may create an account at that time. In one embodiment, user accounts are processed by the computer and stored in a platform's server and its database.

In one embodiment, a user may enter a value to purchase for the selected fractionalized digital asset. In one embodiment, the system determined how much of the fractionalized digital asset to buy. In another embodiment, the system executes an order for as much of the fractionalized digital asset as is possible based on the amount entered by the purchaser.

In one embodiment, fractional digital asset(s) have an individual cost, have a collective uniform cost for each item, or have a mixture of prices in each item. In one embodiment, each fractional digital asset may have its price that are different from other fractional digital asset of the same overall digital asset. In one embodiment, each fractionalized digital asset is independent and may be different from the price(s) of the following fractionalized part of the digital asset, if any. In another embodiment, fractionalized digital asset(s) prices are determined by market conditions and through well established principles of supply and demand.

In one embodiment, the system may establish a time period for purchasing each fractionalized digital asset for the price so designed at the time. In one embodiment, the time period may be set by the system and programming into the server. In one embodiment, the recipient may be provided with options of recommended time periods to select. In another embodiment, the seller may custom select a time period for the amount of time allowed for purchaser to finalize execution on the fractionalized digital asset. In another embodiment, the transaction must be instantaneous or near instantaneous. In another embodiment, the transaction occurs once a sell price and a purchase price are agreeable by both sides of the transaction. In another embodiment, a combination of different options provided may be available.

In one embodiment, the system has a method of calculating the number of digital asset fractionalized parts and the part prices for each part. In another embodiment, the system provides options for the user to select the digital asset visual representative's fractionalized prices and number of associated fractionalized parts. In another embodiment, the system provides an exchange market, similar to the stock exchange, whereby the seller can list the digital asset's fractionalized assets for a minimum or set price, and a buyer can make an offer to buy at a set price or maximum price.

In one embodiment, the systems and methods disclosed herein enhance the experience by giving users a tool to track a price of a fractionated digital asset, and execute a purchase of a fractionalized digital asset at a price level the user determines.

As examples of creating fractional ownership of assets using visual representative parts, without limiting the invention:

Example 1: A NFT of a video showing a famous athlete's special moment is available for sale. The owner decides to crowdfund the sell of the NFT so the owner uses the part system option. The NFT's value is $300,000. The part system makes 100 parts each valued at $3,000 and the parts are made available for sell. The parts are each identified by a blockchain to keep track of their ownership and ownership transfers. The owner of the NFT decides to keep 15 parts, valued at $45,000. Individual A buys 50 parts for $150,000, individual B buys 20 parts for $60,000, corporation C buys 5 parts for $15,000, and various individuals and corporations buy the remaining 10 parts. A year later, individual B decides to sell 10 parts of the NFT for $3,500 each, and individual D buys all 10.

Example 2: A person sells an investment real estate using the parts system. The real estate is valued at $500,000, and divided into 1,000 parts of $500 each. Various individuals and corporations buy parts, and collectively pay the $500,000. The parts are evidence of the ownership and an asset themselves, and so some individuals decide to resell their parts at a markup of 10%, or $550 each part. Other individuals buy the parts, and so establish equity ownership in the home. The parts are proof of ownership in their respective shares of the home.

Example 3: An individual files for a patent. That person then decides to sell interests in that patent application by way of fractionation or parts. The patent is divided into 250 parts, each valued at $100. The patent filer sells or transfers as many of the 250 parts to others, and the part holders are owners in their respective shares of the patent.

Referring to FIG. 33, in one embodiment, a software methods allows users to track a fractionalized digital asset's purchase price, set an automated execution and/or notice upon a price limit being reached, and execute either a notice and/or purchase at that price, within either a predefined time period or no predefined time period.

In one embodiment, the systems and methods disclosed herein allow users to use the internet to track a fractionalized digital asset's price fluctuations. In one embodiment, when and if the price reaches a set amount, as determined by the user, the user may receive a notification and/or an order may be immediately executed by the system.

In one embodiment, the user may select the fractionalized digital asset he or she wishes to track the price for. In one embodiment, the user may enter a date range for price tracking, with a start date and an end date. In one embodiment, the user may only select an end date. In another embodiment, the user may only select a start date. In one embodiment, the systems and methods disclosed herein will preferably track the price of the digital asset over the time set (or infinitely long if no time limit was set).

In one embodiment, if the system finds that the price selected by the user is at or below the current sale price, the system sends a notification to the user; notifications can be sent in any method of communication. In another embodiment, if the system finds that the price selected by the user is at or below the current sale price, the system executes a purchase of the digital asset using the payment method selected by the user. In another embodiment, a combination of all the methods is used, including both communication and execution of purchase.

In one embodiment, the seller selling the digital asset is made aware of or can be notified that a potential buyer has set a limit price for notification and/or execution of purchase. In another embodiment, once the seller is/are notified of the limit price set by the user, the seller can drop the price of the digital asset to the limit price as set by the buyer. If the seller drops the price of the item to the amount set by the potential buyer, an embodiment provides that the user may be notified of that price drop. In another embodiment, once the seller drops the price to the limit price set by the potential buyer, or below such price, the purchase is automatically executed.

In one embodiment, the seller may be notified that the potential buyer has set a limit price for notification and/or execution of a purchase. In one embodiment, once the seller(s) is/are notified of the limit price set by the potential purchaser, the seller may agree to and/or actually execute the transaction at the price that the potential buyer has set. In one embodiment, the potential buyer may provide a payment method or account funds to automatically execute payment to the seller that agrees to the price that is no higher than the price set by the potential buyer.

In one embodiment, the potential purchaser may disclose desire to purchase one or multiple digital assets for purchase, whether currently listed for sale on the portal or not, and a highest amount willing to pay; potential seller(s) may then sell such digital asset(s) to the potential purchaser.

In one embodiment, the market systems and methods disclosed herein may be analogous to the current systems and methods provided by current financial exchange markets such as the New York Stock Exchange or NASDAQ, but incorporating the unique invention principles within this patent for the sale, purchase and exchange of fractionalized digital assets. In another embodiment, the methodology of the financial exchanges such as the New York Stock Exchange or NASDAQ, whereby stock buyers set their maximum purchase price and stock sellers set their lowest selling price, is analogously established in this invention's market for the sale, purchase and exchange of fractionalized digital assets. In another embodiment, the transaction of fractional digital assets may be the actual item or its derivative.

In one embodiment, the digital market described here may exist in a physical location, on the world wide web hosted on a computer system, or in a virtual word such as the metaverse. In one embodiment, the fractionation of the digital asset may exist in any form whether through a virtual environment, such as a metaverse, or in non-virtual environments.

The present disclosure is in the technical field of retail, and more particularly the technical field of ecommerce. The present disclosure is in the technical field of computer software, and more particularly in the technical fields of ecommerce and financial investment. The present disclosure is in the field of finance, and more particularly in the technical fields of financial investment. In one embodiment, the systems and methods disclosed herein provides ways for users to fractionalize digital assets and offers a method for authenticating fractional ownership, and maintaining historic chain-of-ownership for fractional and non-fractional ownership.

In one embodiment the fractionalization of assets using the visual representative parts as described in this document is used for digital assets. In another embodiment, the fractionalization of assets using the visual representative parts as described in this document is used for non-digital assets. In another embodiment, the fractionalization of assets using blockchain is used for digital assets. In another embodiment, the fractionalization of assets using blockchain is used for non-digital assets.

There is currently no system in existence that provides a method for a user to fractionalize a unique digit asset, such as a non-fungible (NFT), so that multiple owners can own and be authenticated through an organized system or blockchain.

There is currently no system in existence that provides a method for a user to visualize a fractionalized unique digit asset, such as a non-fungible (NFT), so that the ownership can be easily viewed, understood, exchanged, and described, with regard to multiple owners.

There is currently no system in existence that provides a method for a market, exchange, other internet site or application to provide a method to fractionalize a digital asset and make such fractional portions readily transferable.

The systems and methods disclosed herein provide an improved system, individually and collectively, to own, sell, transfer or otherwise participate in digital assets in a fractional portion of the total digital asset.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

While the foregoing is directed to embodiments of the present invention, other and further embodiments of the invention may be devised without departing from the basic scope thereof, which is only limited by the scope of the claims that follow. For example, the present invention contemplates that any of the features shown in any of the embodiments described herein, or incorporated by reference herein, may be incorporated with any of the features shown in any of the other embodiments described herein, or incorporated by reference herein, and still fall within the scope of the present invention.

What is claimed is:

1. A computer-implemented method for fractionating a digital asset, comprising:
under the control of one or more configured computer systems, operating software that maintains a unique identifier for the digital asset; maintains a unique identifier that can provide adequate information to identify the owner of the digital asset and the owner's fractional ownership interest; and, maintains unique identifiers for each subsequent owners and their fractional ownership interest;
creating a plurality of owners in the same digital asset.

2. The device of claim 1, wherein the digital asset comprises of or is authenticated by a non-fungible token (NFT).

3. The system claimed in claim 2, that appends, amends or modifies the non-fungible token's blockchain so as to include information about the owner's identification and the quantity of the owner's fractional ownership of the digital asset.

4. The device of claim 1, where the digital asset was created or authenticated via tokenization on a blockchain.

5. The system claimed in claim 4, that appends, amends or modifies the blockchain associated with that digital asset so as to include information about the owner's identification and the quantity of the owner's fractional ownership of the digital asset.

6. The device of claim 1, where the digital asset was created via any method that attaches current and prior ownership information in a digital format to the digital asset.

7. The system claimed in claim 6, that appends, amends or modifies the digital information associated with that digital asset so as to include information about the owner's identification and the quantity of the owner's fractional ownership of the digital asset.

8. A computer-implemented method comprising:
under the control of one or more configured computer systems, operating software that maintains a database;
establishes a market;
enables owners of digital assets to fractionalize their digital assets into a plurality of ownership shares to be sold in the market;
establishes a mechanism by which fractional digital assets may be sold, purchased, or exchanged;
establishing a sales price for the digital asset;
enables others to gather information about the fractionalized digital asset, place a bid for the purchase of one or more fractionalized digital asset(s), or purchase the fractionalized digital asset;
automates the fractionalizing of the digital asset;
automates the ownership transfer of the fractionalized digital asset.

9. The device of claim 8, wherein the digital asset comprises of or is authenticated by a non-fungible token (NFT).

10. The device of claim 8, where the digital asset was created via tokenization on a blockchain.

11. The device of claim 8, where the digital asset was created via any method that attaches current and prior ownership information in a digital format to the digital asset.

12. The method as claimed in claim 8, wherein the asset:
can be displayed on a visual display with a visual image that is representative of the digital asset (the “visual representation”);
using a processor for dividing the visual representation of the digital asset into two or more parts that are available for individual purchase by digital asset purchasers;
the selected visual representation being divided into the two or more parts on the visual display by
showing a boundary on the visual display that defines a bounded area,
showing the selected visual representation on the visual display, inside the bounded area and surrounded by the boundary,
generating at least one dividing line inside the bounded area that divides the bounded area into two or more individual sections that are visible on the visual display, wherein each of the visual representation parts is located inside a different one of the individual sections;
assigning a monetary value to each of the respective visual representation parts that is equal to the value of the digital asset represented by the visual representation;
providing a method for others to purchase the digital asset represented by the visual representation.

13. The method as claimed in claim 12, wherein the boundary shown on the visual display comprises one or more boundary lines that define a shape selected from the group consisting of squares, rectangles, parallelograms, triangles, circles, ovals, objects having at least one curved line, and objects having at least one straight line.

14. The method as claimed in claim 12, wherein the at least one dividing line comprises lines selected from the group consisting of horizontal lines, vertical lines, diagonal lines, curved arcs, straight lines, squiggly lines, lines having the appearance of puzzle pieces, and any visual method to divide an image into a plurality of parts.

15. The method as claimed in claim 12, further comprising for each of the visual representations showing an available indicator when the digital asset is available for purchase and an unavailable indicator when the digital asset is unavailable for purchase.

16. The method as claimed in claim 12, further comprising:
selecting one of the visual representation parts shown on the visual display;
showing on the visual display the cost to purchase the selected digital asset represented by the visual representation and a selector button to purchase the selected digital asset.

17. The method as claimed in claim 12, further comprising:
executing a buy order for the selected digital asset represented by the visual representation when the sum of the monetary values of the digital asset equals or is greater than the sales price of the digital asset.

18. The method as claimed in claim 12, further comprising notifying the parties when digital assets represented by visual representations been purchased.

19. The method as claimed in claim 8, further comprising:
a bidding system where the digital asset represented by the visual representation is offered for sale at a ask price and potential buyers provide a buy price;
when the seller's ask price matches or is lower than the buyer's buy price, the sale of the digital asset represented by the visual representation is sold.
